(19) United States
(12) Patent Application Publication
(10) Pub. No.: US 2025/0052626 A1
(43) Pub. Date: Feb. 13, 2025

(54) STRAIN DETECTION DEVICE

(71) Applicant: JAPAN DISPLAY INC., Tokyo (JP)

(72) Inventors: Fumihoru NAKANO, Tokyo (JP); Toshinori UEHARA, Tokyo (JP)

(21) Appl. No.: 18/768,891

(22) Filed: Jul. 10, 2024

(30) Foreign Application Priority Data
Aug. 7, 2023 (JP) 2023-128717

(51) Int. Cl. G01L 1/20; G01L 1/22

(52) U.S. Cl. CPC G01L 1/205; G01L 1/22

(57) ABSTRACT

According to one embodiment, a strain detection device includes a flexible base material, first, second, third, and fourth sensor patterns on the base material, each including a plural strain gauges provided in a row. First strain gauges of the first sensor pattern, second strain gauges of the second sensor pattern, third strain gauges of the third sensor pattern, and fourth strain gauges of the fourth sensor pattern are arranged facing each other in a thickness direction of the base material. The first and fourth strain gauges are arranged symmetrically with a center position of the base material in the thickness direction, and the second and third strain gauges are arranged symmetrically with the center position of the base material in the thickness direction.

### CROSS-REFERENCE TO RELATED APPLICATIONS

This application is based upon and claims the benefit of priority from Japanese Patent Application No. 2023-128717, filed Aug. 7, 2023, the entire contents of which are incorporated herein by reference.

### FIELD

Embodiments described herein relate generally to a strain detection device.

### BACKGROUND

As an example of a strain detection device, a flexible film or sheet-shaped strain gauge sensor is known. The strain gauge sensor includes strain gauges provided side by side on a surface of a strip-shaped flexible sheet substrate and a plurality of signal lines for energizing these strain gauges. A plurality of strain gauges are also provided on the front and back sides of the sheet. The strain gauges on the front side are arranged facing the strain gauges on the back side, respectively. By wrapping the strain gauge sensor around a curved subject and detecting the resistance change of each strain gauge, the curved shape of the subject can be detected.

### BRIEF DESCRIPTION OF THE DRAWINGS

FIG. 1 is perspective view of a strain gauge sensor device according to an embodiment.

FIG. 2 is a longitudinal cross-sectional view of the strain gauge sensor device.

FIG. 3 is a cross-sectional view of the strain gauge sensor device along line A-A of FIG. 2.

FIG. 4 is a longitudinal cross-sectional view of a strain gauge sensor device according to a modified example.

FIG. 5 is a schematic development view showing strain gauges and conductive lines of second and third sensor patterns of the gauge sensor device according to the embodiment.

FIG. 6 is a schematic perspective view showing a stacking structure of sensor patterns of a first sensor sheet in the strain gauge sensor device.

FIG. 7 is a block diagram of a controller of the strain gauge sensor device.

FIG. 8 is a plan view of first to fourth sensor patterns of the strain gauge sensor device and an analog front end of a controller, showing a scanning operation at the time of detection.

FIG. 9 is a circuit diagram of a differential detection circuit in the analog front end.

FIG. 10 is a schematic side view showing a state in which the strain gauge sensor device is installed on a surface of a subject.

FIG. 11 is a schematic view showing a part of the strain gauge sensor device in the state of being installed on the surface of the subject.

FIG. 12 is a plan view of first to fourth sensor patterns of the strain gauge sensor device and an analog front end of a controller, showing a scanning operation at the time of detection.

FIG. 13A schematically shows an example of strain detection performed by second and third layers of strain gauges in a part of the strain gauge sensor device shown in FIG. 11.

FIG. 13B schematically shows an example of strain detection performed by first and fourth layers of strain gauges in a part of the strain gauge sensor device shown in FIG. 11.

FIG. 14 shows a curved surface morphology in which radii of curvature calculated based on detection values detected by the strain gauges of the second and third layers are plotted.

FIG. 15 shows a curved surface morphology in which radii of curvature calculated based on detection values detected by the strain gauges of the first and fourth layers are plotted.

FIG. 16 shows a curved surface morphology that plots an average value of a radius of curvature calculated as final data.

FIG. 17 schematically shows a dynamic range of inner and outer strain gauges.

### DETAILED DESCRIPTION

Various embodiments will be described hereinafter with reference to the accompanying drawings. In general, according to one embodiment, a strain detection device comprises: a flexible base material including a plurality of insulating layers; a first sensor pattern provided on the base material, which includes a plurality of first strain gauges provided in a row spaced apart in a first direction and a plurality of conductive lines connected respectively to the first strain gauges; a second sensor pattern, which includes a plurality of second strain gauges provided in a row spaced apart in the first direction and a plurality of conductive lines connected respectively to the second strain gauges, and which is stacked on the base material and faces the first sensor pattern with an insulating layer in between; a third sensor pattern, which includes a plurality of third strain gauges provided in a row spaced apart in the first direction and a plurality of conductive lines connected respectively to the third strain gauges, and which is stacked on the base material and faces the second sensor pattern with an insulating layer in between; a fourth sensor pattern, which includes a plurality of fourth strain gauges provided in a row spaced apart in the first direction and a plurality of conductive lines connected respectively to the fourth strain gauges, and which is stacked on the base material and faces the third sensor pattern with an insulating layer in between; and a controller that applies voltage to the first strain gauges, the second strain gauges, the third strain gauges, and the fourth strain gauges via the plurality of conductive lines and reads a detection value of each strain gauge. The first strain gauges, the second strain gauges, the third strain gauges, and the fourth strain gauges are arranged facing each other in a thickness direction of the base material. The first strain gauges and the fourth strain gauges are arranged symmetrically with respect to a center position of the base material in the thickness direction, and the second strain gauges and the third strain gauges are arranged symmetrically with respect to the center position of the base material in the thickness direction.

Note that the disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, etc., of the respective parts are schematically illustrated in the drawings, compared to the actual modes. Further, in the specification and drawings, corresponding elements are denoted by like reference numerals, and a detailed description thereof may be omitted unless otherwise necessary.

### Embodiment

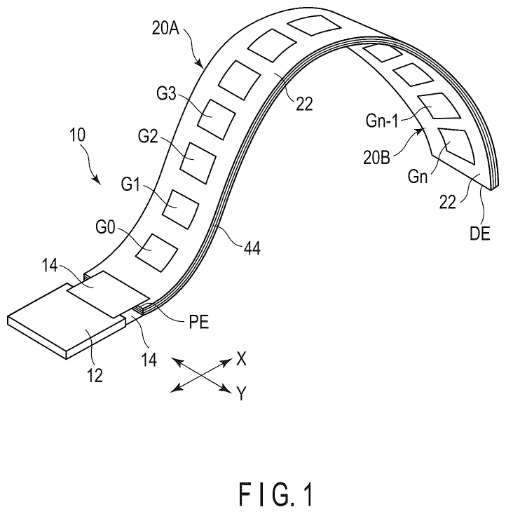

As an example of a strain detection device, a strain gauge sensor device according to an embodiment will be described in detail. FIG. 1 is a perspective view of the strain gauge sensor device according to the embodiment.

As shown, a strain gauge sensor device 10 configures a double-sided strain gauge sensor. The strain gauge sensor device 10 comprises an elongated strip-shaped flexible base substrate 44 that serves as a base material, a first sensor sheet 20A attached to a first main surface (front surface) of the base substrate 44, a second sensor sheet 20B attached to a second main surface (back surface) of the base substrate 44, a pair of flexible circuit boards (FPC) 14, and a relay board (drive circuit board) 12 connected to the first sensor sheet 20A and the second sensor sheet 20B via the pair of flexible circuit boards 14. In one example, the base substrate 44 is an insulating layer and is formed of a resin such as polyethylene terephthalate (PET), polyimide with a thickness of approximately 0.3 to 0.5 mm.

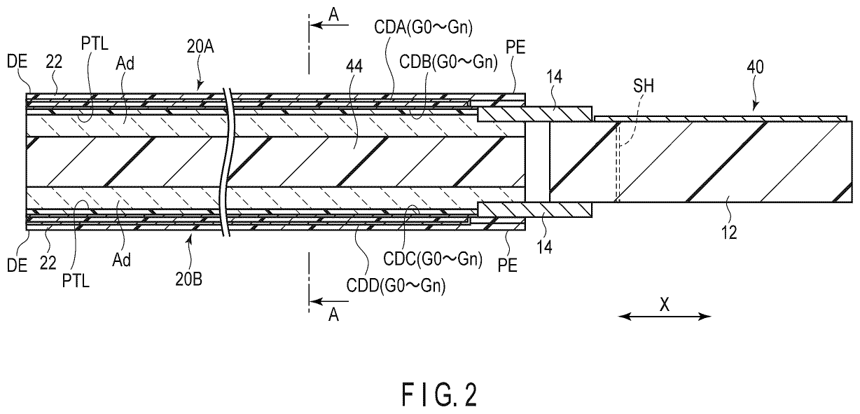

Each of the first sensor sheet 20A and the second sensor sheet 20B includes an elongated strip-shaped flexible sheet base material 22 made of an insulating layer and two layers of conductor patterns (sensor patterns) CDA and CDB (CDC and CDD) (see FIG. 2) provided on the sheet base material 22. Each of the first sensor sheet 20A and the second sensor sheet 20B has one end (distal end) DE in a longitudinal direction X and the other end (proximal end) PE in the longitudinal direction X. The proximal end PE of each of the first sensor sheet 20A and the second sensor sheet 20B is connected to the relay substrate 12. The sensor patterns of each layer include a plurality of strain gauges G0 to Gn. The plurality of strain gauges G0 to Gn are arranged in a row in the longitudinal direction X at a predetermined interval from the distal end DE to the proximal end PE of the longitudinal direction X of the sheet base material 22.

Note that, in the drawing, the longitudinal direction X and a width direction Y of the sensor sheet are two mutually orthogonal directions. These directions may intersect at an angle other than 90 degrees.

FIG. 2 is a longitudinal cross-sectional view of the strain gauge sensor device 10.

As shown in FIG. 2, the base substrate 44 includes a front surface and a back surface facing the front surface. In one example, the first sensor sheet 20A is attached to the front surface of the base substrate 44 by an adhesive layer Ad, such as a transparent adhesive sheet (OCA). The second sensor sheet 20B is attached to the back surface of the base substrate 44 by the adhesive layer Ad.

The relay board 12 includes a drive circuit 40 and a plurality of conductive lines provided on one surface side and a plurality of conductive lines provided on the other surface side, not shown. The first sensor pattern CDA and the second sensor pattern CDB of the first sensor sheet 20A are connected to the conductive lines provided on a top surface side of the relay board 12 via the FPC 14. Similarly, the third sensor pattern CDC and the fourth sensor pattern CDD of the second sensor sheet 20B are connected to the conductive lines provided on a bottom surface side of the relay board 12 via the FPC 14.

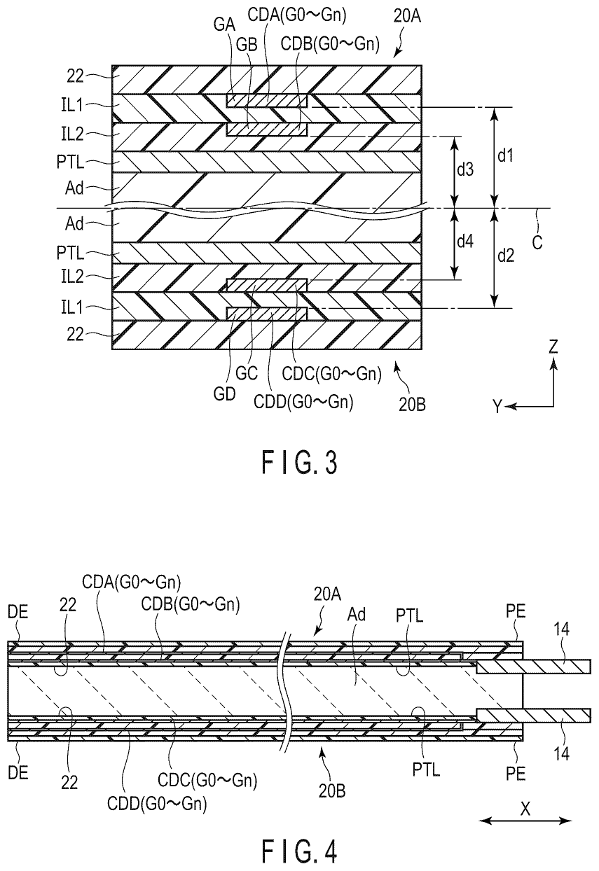

FIG. 3 is a cross-sectional view of the strain gauge sensor device along line A-A in FIG. 2. As shown in the drawing, the first sensor sheet 20A includes the flexible strip-shaped sheet base material 22, the first sensor pattern CDA (G0 to Gn) provided on one surface side of the sheet base material 22, a first insulating layer IL1 stacked on the sheet base material 22 over the first sensor pattern CDA, the second sensor pattern CDB (G0 to Gn) provided on the first insulating layer IL1, a second insulating layer IL2 stacked on the first insulating layer IL1 over the second sensor pattern CDB, and the protective layer (surface protection film) PTL provided on the second insulating layer IL2. In one example, the sheet base material 22 is formed of polyimide, and the first and second insulating layers IL1 and IL2 are formed of silicon nitride (SiN). In one example, the first sensor sheet 20A is bonded to the base substrate 44 by an adhesive layer Ad on the side of the protective layer PTL.

Similarly, the second sensor sheet 20B includes the flexible strip-shaped sheet base material 22, the fourth sensor pattern CDD provided on one surface side of the sheet base material 22, the first insulating layer IL1 stacked on the sheet base material 22 over the fourth sensor pattern CDD, the third sensor pattern CDC provided on the first insulating layer IL1, the second insulating layer IL2 stacked on the first insulating layer IL1 over the third sensor pattern, and the protective layer (surface protection film) PTL provided on the second insulating layer IL2. In one example, the sheet base material 22 is formed of polyimide, and the first and second insulating layers IL1 and IL2 are formed of silicon nitride (SiN). In one example, the second sensor sheet 20B is bonded to the base substrate 44 by the adhesive layer Ad on the side of the protective layer PTL.

The entire base substrate 44, adhesive layer Ad, first sensor sheet 20A, and second sensor sheet 20B are referred to as the base material, the strain gauge of the first sensor pattern CDA is referred to as a first strain gauge GA, the strain gauge of the second sensor pattern CDB is referred to as a second strain gauge GB, the strain gauge of the third sensor pattern CDC is referred to as a third strain gauge GC, and the strain gauge of the fourth sensor pattern CDD is referred to as a fourth strain gauge GD.

As shown in FIG. 3, the first strain gauge GA, the second strain gauge GB, the third strain gauge GC, and the fourth strain gauge GD are each arranged facing each other in a thickness direction Z of the base material with an insulating layer in between. In a case where a location of the center of the base material in the thickness direction Z is a center line C, the first strain gauge GA and the fourth strain gauge GD on the outer side are arranged symmetrically with respect to the center line C, and the second strain gauge GB and the third strain gauge GC on the inner side are arranged symmetrically with respect to the center line C. That is, in a case where a distance between the outer first strain gauge GA and the center line C is d1, a distance between the outer fourth strain gauge GD and the center line C is d2, a distance between the inner second strain gauge GB and the center line C is d3, and a distance between the inner third strain gauge GC and the center line C is d4, d1=d2 and d3=d4 are desirable. D1≠d3 and d2≠d4 are also acceptable.

Note that, in the base material, the first sensor sheet 20A and the second sensor sheet 20B may be configured such that the side of the protective layer PTL is bonded to the base substrate 44 by the adhesive layer Ad, respectively. Also, as shown in FIG. 4, the base substrate may be omitted, and the first sensor sheet 20A and the second sensor sheet 20B may be configured to be bonded to each other by an adhesive layer Ad such as a transparent adhesive sheet (OCA).

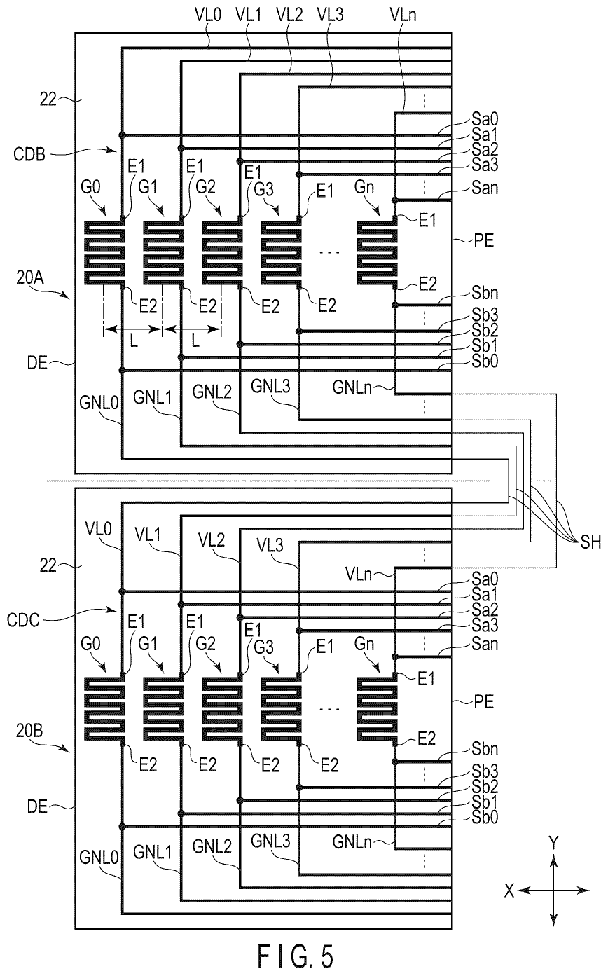

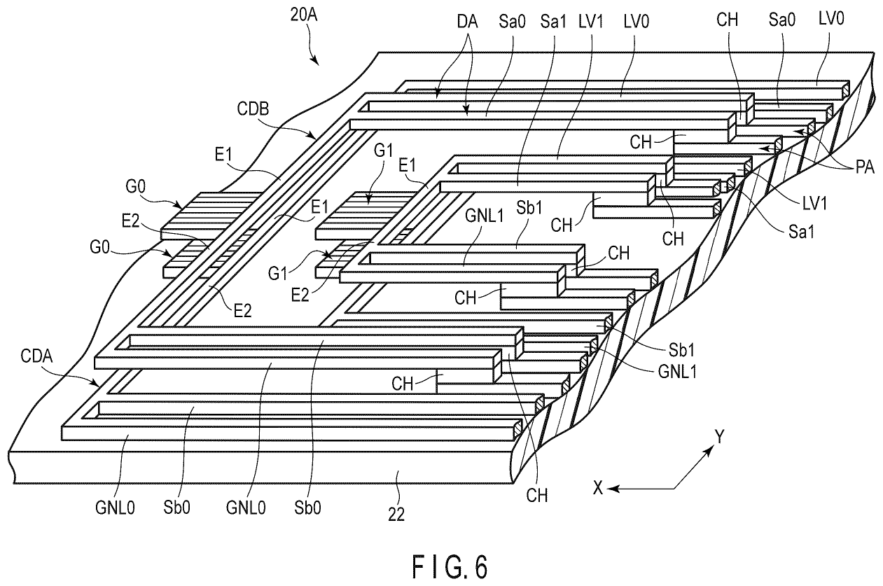

FIG. 5 is a plan schematic development view of the second sensor pattern CDB of the first sensor sheet 20A and the third sensor pattern CDC of the second sensor sheet 20B, and FIG. 6 is a schematic perspective view of a stacking structure of the first sensor pattern CDA and the second sensor pattern CDB in the first sensor sheet 20A.

As shown in FIG. 5, according to the present embodiment, the first sensor sheet 20A and the second sensor sheet 20B are configured in the same shape, dimensions, and sensor pattern. The pattern configurations of the second sensor pattern CDB of the first sensor sheet 20A and the third sensor pattern CDC of the second sensor sheet 20B will be described as representative examples. Each of the sensor patterns include a plurality of strain gauges G0 to Gn. The plurality of strain gauges G0 to Gn are provided in a row with an interval L in the longitudinal direction X from one end (distal end) DE to the other end (proximal end) PE of the sheet base material 22. Each of the strain gauges G0 to Gn extends in a bellows shape or a rectangular wave shape in the width direction Y and has one end (which may be referred to as a first end) E1 and the other end (which may be referred to as a second end) E2 in the width direction Y. Each of the strain gauges G0 to Gn has a desired resistance value and produces a resistance change in response to strain.

Each sensor pattern includes a plurality of power lines VL0 to VLn, a plurality of ground lines GNL0 to GNLn, a plurality of first signal lines Sa0 to San, and a plurality of second signal lines Sb0 to Sbn, each extending in the longitudinal direction X along a row of strain gauges G0 to Gn.

The power lines VL0 to VLn are located on one end side of the strain gauges G0 to Gn. The power lines VL0 to VLn have one end connected to the first ends E1 of the strain gauges G0 to Gn and the other end extending to the proximal end PE of the sheet base material 22, and extend approximately parallel to each other.

The first signal lines Sa0 to San are located between the first ends E1 of the strain gauges G0 to Gn and the power lines VL0 to VLn. The first signal lines Sa0 to San have one end connected to the first ends E1 of the strain gauges G0 to Gn and the other end extending to the proximal end PE of the sheet base material 22, and extend approximately parallel to each other.

The ground lines GNL0 to GNLn are located on the side of the other end of the strain gauges G0 to Gn. The ground lines GNL0 to GNLn have one end connected to the second ends E2 of the strain gauges G0 to Gn and the other end extending to the proximal end PE of the sheet base material 22, and extend approximately parallel to each other.

The second signal lines Sb0 to Sbn are located between the other end of the strain gauges G0 to Gn and the ground lines GNL0 to GNLn. The second signal lines Sb0 to Sbn have one end connected to the second ends E2 of the strain gauges G0 to Gn and the other end extending to the proximal end PE of the sheet base material 22, and extend approximately parallel to each other.

As described below, in the present embodiment, the ground lines GNL0 to GNLn of the second sensor pattern CDB are electrically connected to the power lines VL0 to VLn of the third sensor pattern CDC via through holes SH, respectively, at the location of the relay board 12. As a result, each strain gauge of the second sensor pattern CDB is connected in series with each strain gauge of the third sensor pattern.

As shown in FIG. 2 and FIG. 3, in the first sensor sheet 20A, the first sensor pattern CDA (G0 to Gn) are formed on the sheet base material 22, and the first insulating layer IL1 is stacked on the sheet base material 22 over the first sensor pattern CDA. The second sensor pattern CDB is formed on the first insulating layer IL1, and the second insulating layer IL2 is stacked on the first insulating layer IL1 over the second sensor pattern CDB.

As shown in FIG. 6, the strain gauges G0 to Gn of the second sensor pattern CDB are located facing the strain gauges G0 to Gn of the first sensor pattern CDA in the thickness direction of the first sensor sheet 20A, respectively.

The power lines VL0 to VLn, the ground lines GNL0 to GNLn, the first signal lines Sa0 to San, and the second signal lines Sb0 to Sbn of the second sensor pattern CDB are respectively located slightly displaced in the width direction Y with respect to the power lines VL0 to VLn, the ground lines GNL0 to GNLn, the first signal lines Sa0 to San, and the second signal lines Sb0 to Sbn of the first sensor pattern CDA.

The power lines VL0 to VLn, the ground lines GNL0 to GNLn, the first signal lines Sa0 to San, and the second signal lines Sb0 to Sbn of the second sensor pattern CDB have a distal end portion DA connected to the strain gauges G0 to Gn and a proximal end portion PA extending to the proximal end PE of the sheet base material 22. Each distal end portion DA is provided on the first insulating layer IL1, and the proximal end portion PA is provided on the sheet base material 22. The distal end portion DA is electrically connected to the proximal end portion PA via a contact hole CH formed in the first insulating layer IL1.

Thus, the proximal end portions PA of the power lines VL0 to VLn, the ground lines GNL0 to GNLn, the first signal lines Sa0 to San, and the second signal lines Sb0 to Sbn of the second sensor pattern CDB are located in the same plane as the power lines VL0 to VLn, the ground lines GNL0 to GNLn, the first signal lines Sa0 to San, and second signal lines Sb0 to Son of the first sensor pattern CDA, that is, on the sheet base material 22 and connected to the common FPC 14 conductive lines.

The third sensor pattern CDC and the fourth sensor pattern CDD of the second sensor sheet 20B are formed in the same shape, dimensions, and structure as those of the first sensor pattern CDA and the second sensor pattern CDB of the first sensor sheet 20A described above.

As shown in FIG. 2, the first sensor sheet 20A and the second sensor sheet 20B configured as described above are attached to the front and back surfaces of the base substrate 44 and face each other with the base substrate 44 in between. That is, the two layers of strain gauges G0 to Gn of the first sensor sheet 20A face the two layers of strain gauges G0 to Gn of the second sensor sheet 20B, respectively, with the base substrate 44 in between. Here, it is preferable that each of the strain gauges G0 to Gn of the first sensor sheet 20A and each of the strain gauges G0 to Gn of the second sensor sheet are at least partially superimposed on each other in a plan view viewed from a direction perpendicular to the surface of the base substrate 44. Alternatively, it is preferable that the strain gauges G0 to Gn of each of these sensor sheets 20A and 20B are at least superimposed on each other without being displaced in the width direction Y while allowing for displacement in the longitudinal direction X. It is more preferable that the strain gauges G0 to Gn of each of these sensor sheets 20A and 20B are superimposed without being displaced in either the longitudinal direction X or in the width direction Y.

The conductive lines of the first sensor pattern CDA and the second sensor pattern CDB of the first sensor sheet 20A extend to the top surface of the relay board 12 via the FPC 14. The conductive lines of the third sensor pattern CDC and the fourth sensor pattern CDD of the second sensor sheet 20B extend to the back surface of the relay board 12 via the FPC 14. In the present embodiment, the ground lines GNL0 to GNLn of the first sensor pattern CDA are electrically connected to the power lines VL0 to VLn of the fourth sensor pattern CDD by the plated-through holes SH as connection lines formed on the relay board 12, respectively. Furthermore, the ground lines GNL0 to GNLn of the second sensor pattern CDB are electrically connected to the power lines VL0 to VLn of the third sensor pattern CDC by the plated-through holes SH as connection lines formed on the relay board 12, respectively.

Note that, the connection line is not limited to the plated-through hole SH, and may use a wiring pattern on the relay board 12, etc. It is also possible to adopt a configuration in which the FPC 14 on the second sensor sheet 20B side is connected to the top surface side of the relay board 12 so that the ground lines GNL0 to GNLn of the first sensor sheet 20A are connected to the power lines VL0 to VLn of the second sensor sheet 20B respectively via the conductive lines on the relay board 12 instead of plated-through holes. Furthermore, it is also possible to adopt a configuration in which the FPC 14 on the first sensor sheet 20A side and the FPC 14 on the second sensor sheet 20B side are connected to the drive circuit 40 provided on the top surface side of the relay board 12, and the ground lines GNL0 to GNLn of the first sensor sheet 20A are connected to the power lines VL0 to VLn of the second sensor sheet 20B respectively in the drive circuit 40.

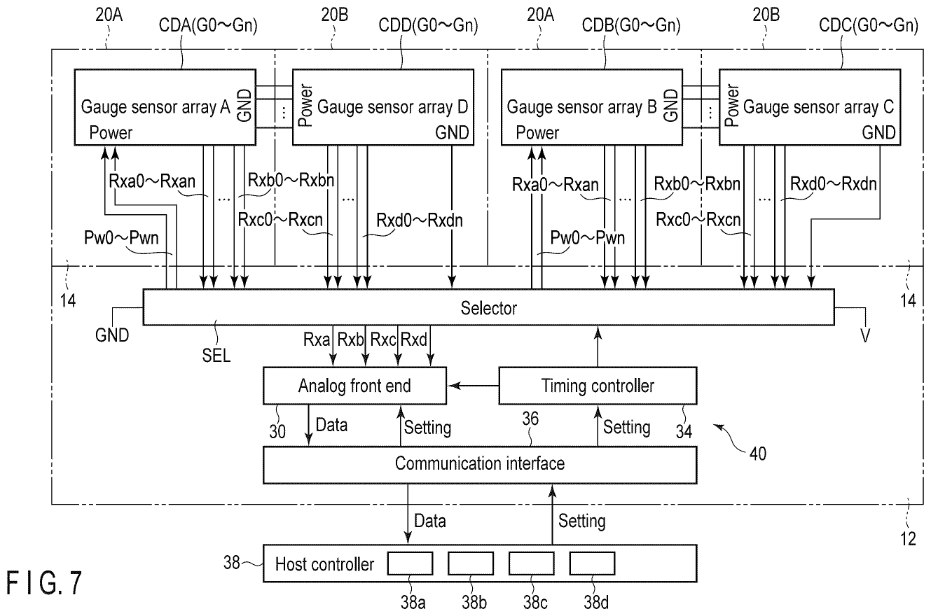

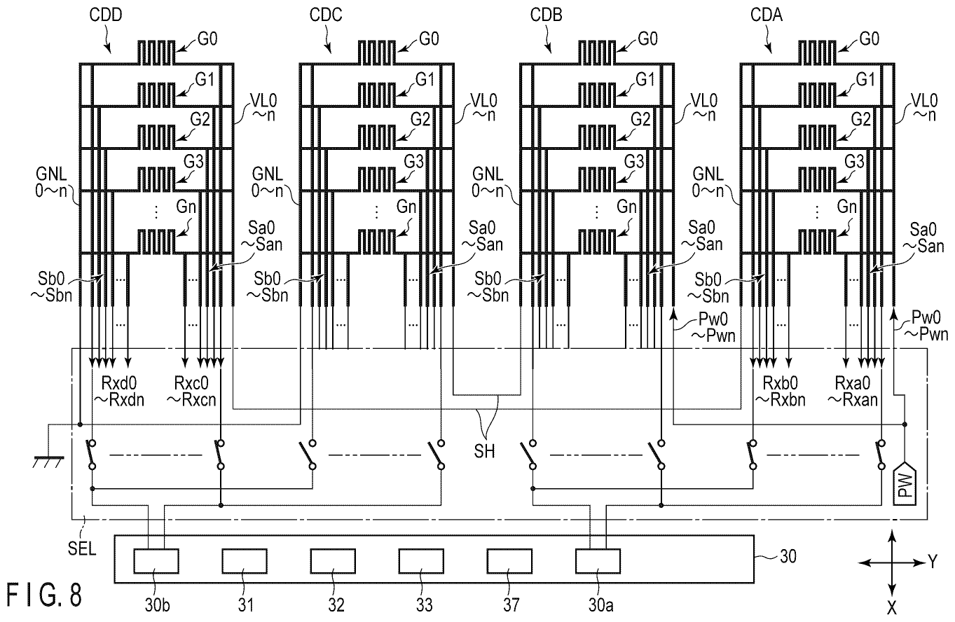

Next, a drive circuit (controller) that drives the first sensor sheet 20A and the second sensor sheet 20B configured as described above will be described. FIG. 7 is a block diagram schematically showing the drive circuit of the strain gauge sensor device 10, and FIG. 8 is a block diagram showing the first to fourth sensor patterns, and a selector and analog front end of the controller. Note that, in FIG. 8, to simplify the drawing, the power lines VL0 to VLn of each sensor pattern are grouped together in one power line, and the ground lines GNL0 to GNLn are grouped together in one power line.

As shown in FIG. 7, the drive circuit 40 provided on the relay board (control circuit board) 12 includes a selector SEL, an analog front end (signal conditioning circuit (AFE)) 30, a timing controller 34, and a communication interface 36.

The communication interface 36 is connected wirelessly or by wire to an external host controller 38, receives drive signals (setting) from the host controller 38, and transmits detection data (Data) to the host controller 38.

Timing controller 34 outputs drive signals to the selector SEL and the analog front end 30 according to the drive signals (setting).

The selector SEL is configured by a plurality of shift registers, multiplexers, and the like. In response to a drive signal from the timing controller 34, the selector SEL connects the power lines VL0 to VLn of the first and second sensor patterns CDA and CDB in the first sensor sheet 20A sequentially to the power supply and applies voltages PW0 to PWn to the strain gauges G0 to Gn sequentially. In synchronization with this, the selector SEL sequentially reads detection signals (voltage values) RXa0 to RXan and RXb0 to RXbn at one end and the other end of each strain gauge G0 to Gn via the first signal lines Sa0 to San and second signal lines Sb0 to Sbn.

The voltages PW0 to PWn supplied to the power lines VL0 to VLn of the first and second sensor patterns CDA and CDB are sequentially applied to the power lines VL0 to VLn of the third and fourth sensor patterns CDC and CDD via the ground lines GNL0 to GNLn and a connection line SH. In synchronization with the above reading, the selector SEL sequentially reads detection signals (voltage values) RXc0 to RXcn and RXd0 to RXdn at one end and the other end of each strain gauge G0 to Gn via the first signal lines Sa0 to San and the second signal lines Sb0 to Sbn of the third and fourth sensor patterns CDC and CDD in the second sensor sheet 20B.

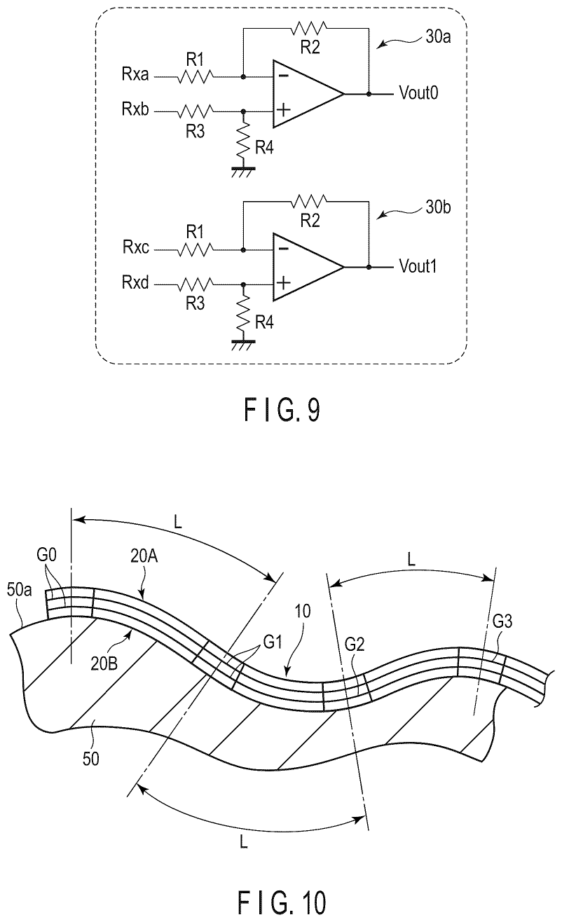

As shown in FIG. 8, the analog front end 30 includes a readout circuit 31, differential detection circuits 30a and 30b, an AD converter 32, a digital filter 33, and a memory 37, etc. FIG. 9 is a circuit diagram of the differential detection circuits in the analog front end. As shown in the drawing, according to the present embodiment, the analog front end 30 includes the differential detection circuit (subtraction circuit) 30a that processes the detection signal of the first sensor sheet 20A and the differential detection circuit (subtraction circuit) 30b that processes the detection signal of the second sensor sheet 20B. The analog front end 30 performs signal adjustment (amplification, AD conversion, filtering) for the detection signals RXa and RXb and the detection signals RXc and RXd of each strain gauge G0 to Gn transmitted from the selector SEL according to the drive signal, and outputs them to the communication interface 36. At this time, since a voltage drop value of each strain gauge G is required to calculate the radius of curvature, the difference between detection values Rxa and Rxb of the strain gauges G0 to Gn and the difference between detection values Rxc and Rxd of the strain gauges G0 to Gn, respectively, are taken by the differential detection circuits 30a and 30b and output as signals.

As shown in FIG. 7, the host controller 38 includes a readout circuit 38a, a memory 38b, and an arithmetic processing unit 38c, etc. The read circuit 38a reads the output signal (differential data) transmitted from the communication interface 36 and stores it in the memory 38b. The arithmetic processing unit 38c, for example, a CPU, performs data forming, surface calculation, and other arithmetic operations based on the differential data to calculate the strain (radius of curvature), curved surface morphology (curved surface coordinates), etc., of the subject detected by the first and second sensor sheets 20A and 20B. The differential data, calculated radius of curvature, curved surface morphology, detection operation program, etc., are stored in the memory 38B.

Next, a detection operation mode of the strain gauge sensor device 10 will be described.

FIG. 10 schematically shows the strain gauge sensor device 10 installed on the surface of a subject 50. As shown in the drawing, in one example, the subject 50 has a surface 50a that is curved in a wavy or sine wave shape. The strain gauge sensor device 10 is installed in close contact with the surface 50a of the subject 50 to detect the curved surface morphology of the subject 50. In this case, the strain gauge sensor device 10 is installed with the second sensor sheet 20B contacting the surface 50a of the subject 50. In one example, each sensor pattern of the first sensor sheet 20A and the second sensor sheet 20B is assumed to have approximately four to eight strain gauges G0 to Gn, respectively. The interval L between adjacent strain gauges is, for example, 5 to 20 mm, more preferably approximately 10 to 15 mm.

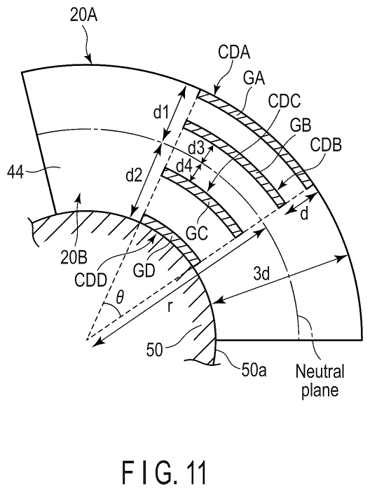

FIG. 11 schematically shows an enlarged portion of the strain gauge sensor device 10 installed on the surface 50a of the subject 50. As shown in the drawing, when installed on the surface 50a, a neutral plane of the base substrate 44 is curved with a radius of curvature r. Here, the neutral plane is a plane where neither elongation (tension) nor contraction (compression) occurs before and after the curvature of the strain gauge sensor device (i.e., zero strain after the curvature). In the present embodiment, the neutral plane is assumed to be located at the center of the base substrate 44 in the thickness direction (thickness×½).

The strain gauge (sometimes referred to as the first strain gauge) GA of the first sensor pattern CDA and the strain gauge (sometimes referred to as the second strain gauge) GB of the second sensor pattern in the first sensor sheet 20A located on an outer circumference side face each other in the radial direction (thickness direction) with an insulating layer therebetween. The strain gauge (sometimes referred to as the third strain gauge) GC of the third sensor pattern CDC and the strain gauge (sometimes referred to as the fourth strain gauge) GD of the fourth sensor pattern CDD in the second sensor sheet 20B located on an inner circumference side face each other in the radial direction (thickness direction) with an insulating layer therebetween. That is, the four strain gauges GA, GB, GC, and GD, stacked in four layers are spaced apart in the radial direction and face each other. The strain gauge GA is located at the outermost circumference, the strain gauge GD at the innermost circumference, and between them are the two layers of strain gauges GB and GC. Assuming that the distance d between the two facing layers of strain gauges is constant, the thickness of the strain gauge sensor device is 3d.

In a case where a distance between the outermost strain gauge GA and the neutral plane is d1, a distance between the innermost strain gauge GD and the neutral plane is d2, a distance between the middle strain gauge GB and the neutral plane is d3, and a distance between the middle strain gauge GC and the neutral plane is d4, it is preferable that d1=d2 and d3=d4. It may also be d1≠d3 and d2≠d4.

In the detection operation mode, the strain gauges G0 to Gn are driven sequentially by scan driving the power and signal lines, and the detection values of the strain gauges G0 to Gn are read sequentially. In detail, during detection, the timing controller 34 inputs start signals and clock signals synchronized with the start signals to the selector SEL in response to instructions from the host controller 38, and drives (sets) the strain gauges G0 to Gn of the first and second sensor sheets 20A and 20B sequentially during one frame period.

As shown in FIG. 8, the selector SEL first applies voltage to the two strain gauges GA and GD located on the outer side to detect strain. The selector SEL drives the power line VL0 of the first sensor pattern CDA, that is, applies a power voltage to the power line VL0 and applies a desired voltage PW0 to the strain gauge G0. As a result, a current I is passed through the strain gauge G0 for a certain period of time. At the same time, the selector SEL acquires the detection signal (voltage value) RXa0 at one end of the strain gauge G0 and the detection signal (voltage value) RXb0 at the other end of the strain gauge G0 via the first signal line Sa0 and the second signal line Sb0.

The ground line GNL0 of the first sensor pattern CDA is connected to the power line VL0 of the fourth sensor pattern CDD of the second sensor sheet 20B. More specifically, the strain gauge G0 (GA) of the first sensor pattern CDA and the strain gauge G0 (GD) of the fourth sensor pattern CDD are connected in series via the ground line GNL0 of the first sensor pattern CDA, the connection line (plated-through hole) SH, and the power line VL0 of the fourth sensor pattern CDD. Therefore, when the strain gauge G0 of the first sensor pattern CDA is driven, the strain gauge G0 of the fourth sensor pattern CDD is driven synchronously, and the current I is also passed through the strain gauge G0. At the same time, the selector SEL acquires the detection signal (voltage value) RXc0 at one end of the strain gauge G0 and the detection signal (voltage value) RXd0 at the other end of the strain gauge G0 via the first signal line Sa0 and the second signal line Sb0 of the fourth sensor pattern CDD.

The acquired detection signals RXa0, RXb0, RXc0, and RXd0 are transmitted to the analog front end 30. A differential value between detection values Rxa and Rxb is detected and adjusted by the differential detection circuits 30a. A differential value between detection values Rxc and Rxd is detected and adjusted by the differential detection circuits 30b. The adjusted differential values are stored in the memory 37.

Next, the selector SEL drives the power line VL1 of the first sensor pattern CDA and applies a desired voltage PW1 to the strain gauges G1 of the first and fourth sensor patterns CDA and CDD, respectively. As a result, the current I is passed through the two facing strain gauges G1 for a certain period of time. At the same time, the selector SEL acquires the detection signal RXa1 at one end of the strain gauge G1 and the detection signal RXb1 at the other end of the strain gauge G1 via the first signal line Sal and the second signal line Sb1 of the first sensor pattern CDA. At the same time, the selector SEL acquires the detection signal RXc1 at one end of the strain gauge G1 and the detection signal RXd1 at the other end of the strain gauge G1 via the first signal line Sal and the second signal line Sb1 of the fourth sensor pattern CDD.

The acquired detection signals RXa1, RXb1, RXc1, and RXd1 are transmitted to the analog front end 30. A differential value between detection values Rxa and Rxb is detected and adjusted by the differential detection circuits 30a. A differential value between detection values Rxc and Rxd is detected and adjusted by the differential detection circuits 30b. The adjusted differential values are stored in the memory 37.

Thereafter, the selector SEL drives the strain gauges G2 to Gn of the first sensor pattern CDA and the strain gauges G2 to Gn of the fourth sensor pattern CDD sequentially and acquires the detection signals RXa2 to RXan, RXb2 to RXbn, RXc2 to RXcn, and RXd2 to RXdn of the strain gauges G2 to Gn in sequence. The acquired detection signals are sequentially transmitted to the analog front end 30, adjusted and differentially detected, and then stored in the memory 37.

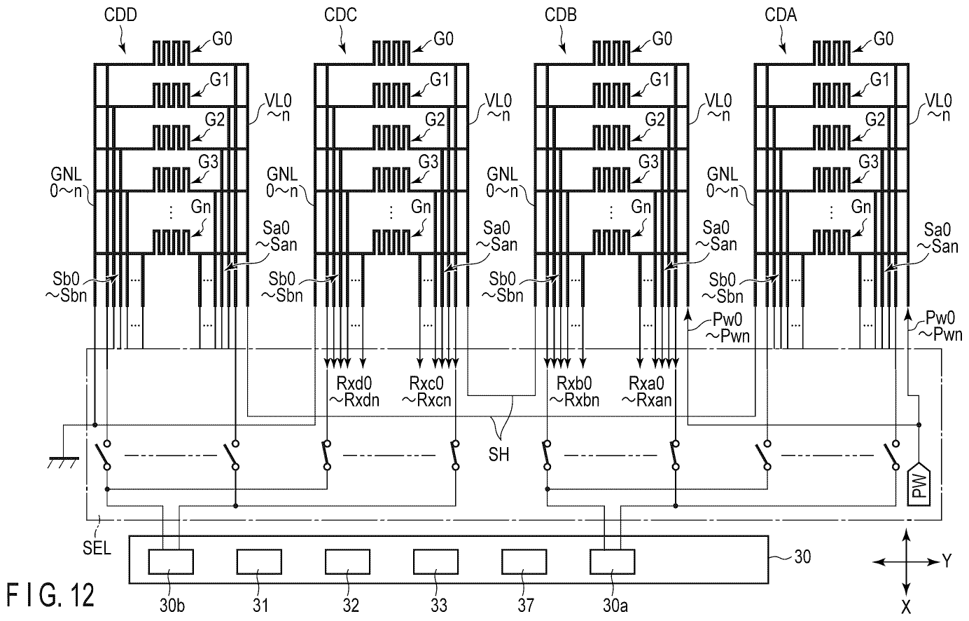

As shown in FIG. 12, the selector SEL then applies voltage to the two strain gauges GB and GC located in the middle (inner) layer to perform strain detection. Note that, in FIG. 12, for simplification of the drawing, the power lines VL0 to VLn of each sensor pattern are grouped together in one power line, and the ground lines GNL0 to GNLn are grouped together in one power line.

In detail, the selector SEL drives the power line VL0 of the second sensor pattern CDB of the first sensor sheet 20A and applies the desired voltage PW0 to the strain gauge G0. As a result, the current I is passed through the strain gauge G0 for a certain period of time. At the same time, the selector SEL acquires the detection signal (voltage value) RXa0 at one end of the strain gauge G0 and the detection signal (voltage value) RXb0 at the other end of the strain gauge G0 via the first signal line Sa0 and the second signal line Sb0.

The ground line GNL0 of the second sensor pattern CDB is connected to the power line VL0 of the third sensor pattern CDC of the second sensor sheet 20B. More specifically, the strain gauge G0 (GB) of the second sensor pattern CDB and the strain gauge G0 (GC) of the third sensor pattern CDC are connected in series via the ground line GNL0 of the second sensor pattern CDB, the connection line (plated-through hole) SH, and the power line VL0 of the third sensor pattern CDC. Therefore, when the strain gauge G0 of the second sensor pattern CDB is driven, the strain gauge G0 of the third sensor pattern CDC is driven synchronously, and the current I is also passed through the strain gauge G0. At the same time, the selector SEL acquires the detection signal (voltage value) RXc0 at one end of the strain gauge G0 and the detection signal (voltage value) RXd0 at the other end of the strain gauge G0 via the first signal line Sa0 and the second signal line Sb0 of the third sensor pattern CDC.

The acquired detection signals RXa0, RXb0, RXc0, and RXd0 are transmitted to the analog front end 30. A differential value between detection values Rxa and Rxb is detected and adjusted by the differential detection circuits 30a. A differential value between detection values Rxc and Rxd is detected and adjusted by the differential detection circuits 30b. The adjusted differential values are stored in the memory 37.

Next, the selector SEL drives the power line VL1 of the second sensor pattern CDB and applies the desired voltage PW1 to the strain gauges G1 of the second and third sensor patterns CDB and CDC, respectively. As a result, the current I is passed through the two facing strain gauges G1 for a certain period of time. At the same time, the selector SEL acquires the detection signal RXa1 at one end of the strain gauge G1 and the detection signal RXb1 at the other end of the strain gauge G1 via the first signal line Sal and the second signal line Sb1 of the second sensor pattern CDB. At the same time, the selector SEL acquires the detection signal RXc1 at one end of the strain gauge G1 and the detection signal RXd1 at the other end of the strain gauge G1 via the first signal line Sal and the second signal line Sb1 of the third sensor pattern CDC.

The acquired detection signals RXa1, RXb1, RXc1, and RXd1 are transmitted to the analog front end 30. A differential value between detection values Rxa and Rxb is detected and adjusted by the differential detection circuits 30a. A differential value between detection values Rxc and Rxd is detected and adjusted by the differential detection circuits 30b. The adjusted differential values are stored in the memory 37.

Thereafter, the selector SEL drives the strain gauges G2 to Gn of the second sensor pattern CDB and the strain gauges G2 to Gn of the third sensor pattern CDD sequentially to acquire the detection signals RXa2 to RXan, RXb2 to RXbn, RXc2 to RXcn, and RXd2 to RXdn of the strain gauges G2 to Gn in sequence. The acquired detection signals are sequentially transmitted to the analog front end 30, adjusted and differentially detected, and then stored in the memory 37.

As described above, the analog front end 30 sequentially reads the transmitted detection signals RXa1 to RXan, RXb1 to RXbn, RXc1 to RXcn, and RXd1 to RXdn by the readout circuit 31, converts them into voltage signals, and further converts them into digital data (Data) by the AD converter 32 and the digital filter 33. Furthermore, the analog front end 30 detects the difference between the detection signals RXa0 to RXan and RXb0 to RXbn, and the difference between the detection signals RXc0 to RXcn and RXd0 to RXdn by the differential detection circuits 30a and 30b. The detected differential data is sequentially stored in the memory 37. When the analog front end 30 completes scanning for one frame period, it reads the differential data for one frame from the memory 37 and outputs it to the host controller 38. The host controller 38 calculates the curved surface morphology of the surface 50a of the subject 50 based on the transmitted data.

The method of calculating the curved surface morphology, in one example, the radius of curvature, will be described.

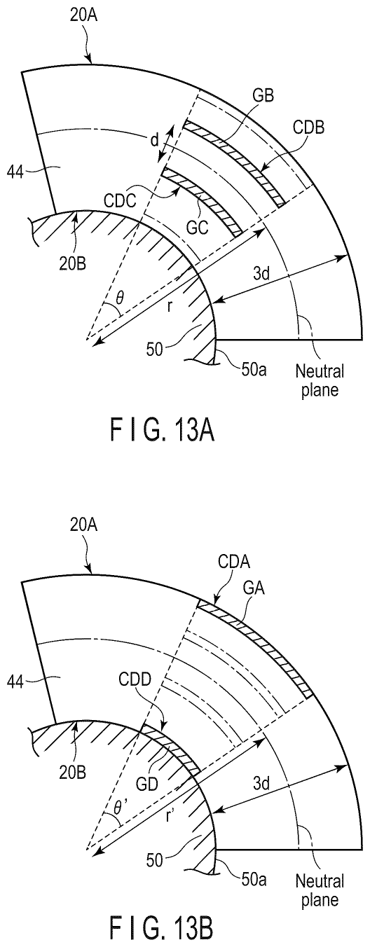

FIG. 13A is a cross-sectional view of the strain gauge sensor schematically showing a case in which the radius of curvature is calculated using the detection values of the middle (inner) two layers of strain gauges GB and GC out of the four layers of strain gauges shown in FIG. 11. FIG. 13B is a cross-sectional view of the strain gauge sensor schematically showing a case where the radius of curvature is calculated using the detection values of the outermost inner (outer) layers of strain gauges GA and GD. The strain gauges GA and GB located on the outer side and the strain gauges GC and GD located on the inner side face each other in the radial direction (in the direction of the thickness of the base material) and are curved with different radii of curvature.

In FIG. 13A and FIG. 13B and the following formulas, reference symbol 3d denotes the thickness of the base material, θ denotes the opening angle of the strain gauge, r denotes the radius of curvature of the neutral plane, k denotes the gauge factor, R0 denotes the initial resistance of the strain gauge, and ΔR0 and ΔR0′ denotes changes in resistance of the strain gauge, respectively.

A case where the radius of curvature is calculated based on the detection values of the strain gauges GB and GC is described. As shown in FIG. 13A, if the length of the strain gauge in the longitudinal direction X at the neutral plane of the base substrate 44 is a strain gauge initial length, the middle outer strain gauge GB is deformed into a state where its length is extended by curving, and the middle inner strain gauge GC is deformed into a state where its length is reduced by curving.

If an initial resistance value of the strain gauges GB and GC before deformation is R0, a measured voltage of the strain gauge GB after deformation (the difference between the voltage values at one end and the other end of the strain gauge) is VB, a measured voltage of the strain gauge GC after deformation is VC, the resistance change of the strain gauges is ΔR0, and the current flowing in each of the strain gauges GB and GC is I, the measured voltages VB and VC of each of the strain gauges GB and GC are as follows.

$$\begin{matrix}{V}_{B} = ( {R}_{0} + Δ {R}_{0} ) \times I \\ {V}_{C} = ( {R}_{0} - Δ {R}_{0} ) \times I\end{matrix}$$

The following equation expresses the relationship of a potential difference at both ends of each strain gauge using the change in strain gauge resistance.

$$\frac{{V}_{C}}{{V}_{B}} = \frac{{R}_{0} - Δ {R}_{0}}{{R}_{0} + Δ {R}_{0}}$$

From the above equation, the rate of change of the strain gauge resistance is calculated by the following equation.

$$\frac{Δ {R}_{0}}{{R}_{0}} = \frac{{V}_{C} - {V}_{B}}{{V}_{C} + {V}_{B}}$$

From the above relational equation, the calculation formula for the radius of curvature r of the neutral plane is as follows.

$$r = \frac{kd}{2} \frac{{R}_{0}}{Δ {R}_{0}}$$

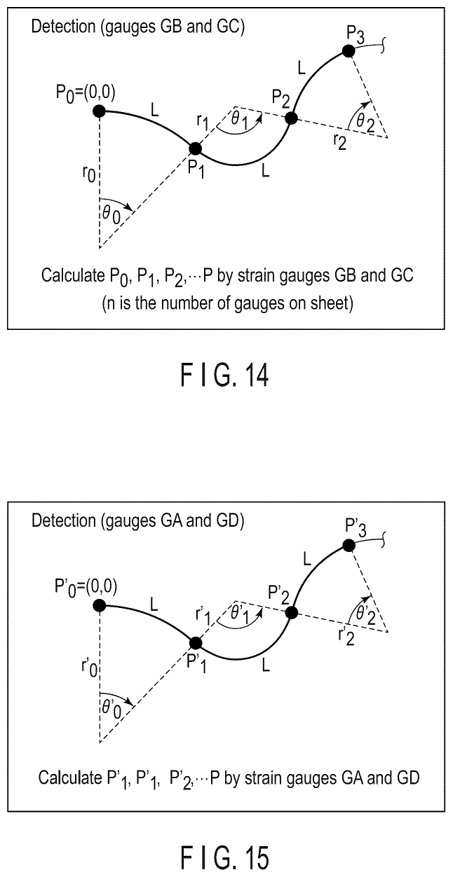

FIG. 14 shows the curved surface morphology in which the radii of curvature (curved surface coordinates) P0 to Pn calculated based on the detection values of the strain gauges GB and GC at locations of a plurality of strain gauges G0 to Gn of the strain gauge sensor system 10 are plotted.

A case where the radius of curvature is calculated based on the detection values of the strain gauges GA and GD is described.

As shown in FIG. 13B, if the length of the strain gauge in the longitudinal direction X at the neutral plane of the base substrate 44 is a strain gauge initial length, the outermost layer strain gauge GA is deformed into a state where its length is extended by curving, and the innermost layer strain gauge GD is deformed into a state where it length is reduced by curving.

If an initial resistance value of the strain gauges GA and GD before deformation is R0, a measured voltage of the strain gauge GA after deformation (the difference between the voltage values at one end and the other end of the gauge) is VA, a measured voltage of the strain gauge GD after deformation is VD, the resistance change of the strain gauges is ΔR0′, and the current flowing in each of the strain gauges GA and GD is I′, the measured values VA and VD of the strain gauges GA and GD are as follows.

$$\begin{matrix}{V}_{A} = ( {R}_{0} + Δ {R}_{0}^{′} ) \times {I}^{′} \\ {V}_{D} = ( {R}_{0} - Δ {R}_{0}^{′} ) \times {I}^{′}\end{matrix}$$

The following equation expresses the relationship of a potential difference at both ends of each strain gauge using the change in strain gauge resistance.

$$\frac{{V}_{D}}{{V}_{A}} = \frac{{R}_{0}^{′} - Δ {R}_{0}^{′}}{{R}_{0}^{′} + Δ {R}_{0}}$$

From the above equation, the rate of change of the strain gauge resistance is calculated by the following equation.

$$\frac{Δ {R}_{0}^{′}}{{R}_{0}^{′}} = \frac{{V}_{D} - {V}_{A}}{{V}_{D} + {V}_{A}}$$

From the above relational equation, the calculation formula for the radius of curvature r′ of the neutral plane is as follows.

$${r}^{′} = \frac{3 kd}{2} \frac{{R}_{0}^{′}}{Δ {R}_{0}^{′}}$$

FIG. 15 shows the curved surface morphology in which the radii of curvature (curved surface coordinates) P′0 to P′n calculated based on the detection values of the strain gauges GA and GD at locations of a plurality of strain gauges G0 to Gn of the strain gauge sensor device 10 are plotted.

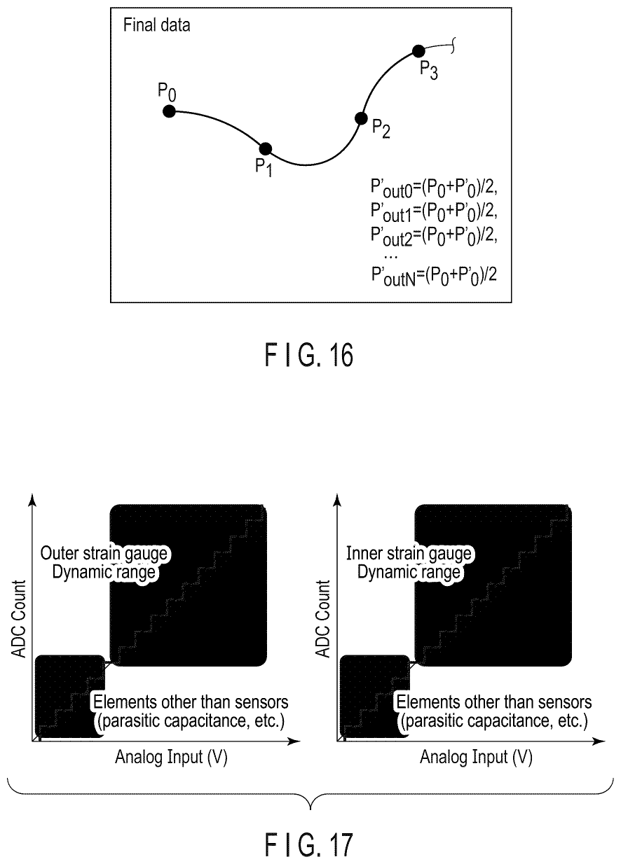

The host controller 38 calculates the curved surface morphology of the surface 50a of the subject 50 based on the transmitted data. An average value ((P0+P0′)/2, (P1+P1′)/2, (P2+P2′)/2, . . . ) of the radii of curvature (curved surface coordinates) P0 to Pn calculated based on the detection values of the strain gauges GB and GC and the radii of curvature (curved surface coordinates) P′0 to P′n calculated based on the detection values of the strain gauges GA and GD is calculated to acquire the radius of curvature (curved surface coordinate) of each section as final data. FIG. 16 shows the curved surface morphology with the calculated radii of curvature P0 to Pn plotted as the final data.

As described above, the strain gauge sensor device 10 can detect the curved surface morphology of the entire surface 50a by sequentially calculating the radii of curvature at a plurality of locations on the surface 50a.

Next, materials for forming the sensor pattern including the strain gauges will be described.

In a case where the strain gauges GB and GC and the strain gauges GA and GD of the strain gauge sensor device are formed of the same material and the same resistance value, the dynamic range of the output value becomes smaller for the inner strain gauges closer to the neutral plane described above. Therefore, the dynamic range of the output value of the inner strain gauge is increased by making the resistance value of the inner strain gauge closer to the neutral plane larger than that of the outer strain gauge.

In one example, the strain gauge GB of the second sensor pattern CDB and the strain gauge GC of the third sensor pattern CDC, which are located on the inner side among the four layers of strain gauges, that is, on the side of the center of the strain gauge sensor device in the thickness direction (neutral plane), are formed of the same material and a material with a higher resistance value, such as titanium. Among the four layers of strain gauges, the strain gauge GA of the first sensor pattern CDA and the strain gauge GD of the fourth sensor pattern CDD, which are located on the outer side, that is, away from the center of the strain gauge sensor device in the thickness direction (neutral plane), are form of the same material, and are further formed of a material with low resistance, such as aluminum. Thus, the inner strain gauges GB and GC and the outer strain gauges GA and GD are formed of different materials, and the inner strain gauges GB and GC are formed of a higher resistance value than the outer strain gauges GA and GD.

In this configuration, by setting the resistance value of each of the inner strain gauges GB and GC and the outer strain gauges GA and GD to an optimum resistance value, the dynamic range of the inner strain gauges can be increased to a range equivalent to that of the outer strain gauges, as shown in FIG. 17. Therefore, the dynamic range of the inner strain gauges GB and GC can be increased, and the quantization error in strain detection can be reduced.

Note that, in the case of bellows-shaped or rectangular wave-shaped strain gauges, the resistance value increases as the number of teeth is increased. Therefore, by forming the strain gauges GA, GB, GC, and GD from the same material and making the number of teeth of the inner strain gauges GB and GC greater than the number of teeth of the outer strain gauges GA and GD, it is possible to increase the resistance of the inner strain gauges GB and GC.

According to the strain gauge sensor device 10 of the present embodiment configured as described above, the two layers of strain gauges G0 to Gn of the first sensor sheet 20A and the two layers of strain gauges G0 to Gn of the second sensor sheet 20B are arranged facing each other in the thickness direction of the base material, and further, the power line of the first sensor sheet and the ground line of the second sensor sheet are connected to connect the strain gauges of the first sensor sheet and the second sensor sheet in series. Therefore, the strain gauges G0 to Gn of the second sensor sheet can be sequentially driven (scanned) in synchronization with the sequential driving (scanning) of the strain gauges G0 to Gn of the first sensor sheet, enabling simultaneous strain detection of the same part by the two strain gauges facing each other on the front and back. Furthermore, during detection, a constant current I can be applied to the two facing strain gauges, and by taking the difference between the detection signals of both strain gauges, it is possible to detect the curved surface morphology with high accuracy.

Furthermore, according to the present embodiment, the strain gauge sensor device includes a plurality of layers, here four layers of strain gauges GA, GB, GC, and GD, arranged overlapping in the thickness direction, and acquires an average value for each pair each, for example, for the detection values detected by the strain gauges GA and GD and the detection values detected by the strain gauges GB and GC as the final detection data. In this manner, by using the average of the detection values detected at a plurality of locations in different thickness directions, the strain gauge sensor device is able to detect the curved surface morphology of the subject with even higher accuracy.

As described above, according to the present embodiment, a strain detection device that can improve detection accuracy can be obtained.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

All configurations that may be designed, modified, and implemented as appropriate by those skilled in the art based on each of the configurations described above as embodiments of the present invention also fall within the scope of the present invention insofar as they encompass the gist of the present invention.

For example, the number of layers of the sensor pattern in the strain gauge sensor device, that is, the number of layers of strain gauges, is not limited to four layers, but can be six, eight, ten, or more layers. The number of arrays of strain gauges in the sensor pattern of the sensor sheet is not limited to the embodiment described above, but can be selected arbitrarily. The composition material, dimensions, and shape of the sensor sheet are not limited to the above-mentioned embodiment, but can be changed as needed. The connection line connecting the power line and the ground line is not limited to a plated-through hole, but can be configured by a conductive line in the selector SEL.

What is claimed is:

1. A strain detection device comprising:
a flexible base material including a plurality of insulating layers;
a first sensor pattern provided on the base material, which includes a plurality of first strain gauges provided in a row spaced apart in a first direction and a plurality of conductive lines connected respectively to the first strain gauges;
a second sensor pattern, which includes a plurality of second strain gauges provided in a row spaced apart in the first direction and a plurality of conductive lines connected respectively to the second strain gauges, and which is stacked on the base material and faces the first sensor pattern with an insulating layer in between;
a third sensor pattern, which includes a plurality of third strain gauges provided in a row spaced apart in the first direction and a plurality of conductive lines connected respectively to the third strain gauges, and which is stacked on the base material and faces the second sensor pattern with an insulating layer in between;
a fourth sensor pattern, which includes a plurality of fourth strain gauges provided in a row spaced apart in the first direction and a plurality of conductive lines connected respectively to the fourth strain gauges, and which is stacked on the base material and faces the third sensor pattern with an insulating layer in between; and
a controller that applies voltage to the first strain gauges, the second strain gauges, the third strain gauges, and the fourth strain gauges via the plurality of conductive lines and reads a detection value of each strain gauge, wherein
the first strain gauges, the second strain gauges, the third strain gauges, and the fourth strain gauges are arranged facing each other in a thickness direction of the base material, and
the first strain gauges and the fourth strain gauges are arranged symmetrically with respect to a center position of the base material in the thickness direction, and the second strain gauges and the third strain gauges are arranged symmetrically with respect to the center position of the base material in the thickness direction.

2. The strain detection device of claim 1, wherein
the plurality of conductive lines of the first sensor pattern include a plurality of power lines and a plurality of first signal lines each connected to a first end of the first strain gauges, and a plurality of ground lines and a plurality of second signal lines each connected to a second end of the first strain gauges,
the plurality of conductive lines of the fourth sensor pattern include a plurality of power lines and a plurality of first signal lines each connected to a first end of the fourth strain gauges, and a plurality of ground lines and a plurality of second signal lines each connected to a second end of the fourth strain gauges, and
each of the first strain gauges is connected in series to the fourth strain gauges via the ground lines of the first sensor pattern and the power lines of the fourth sensor pattern.

3. The strain detection device of claim 2, wherein
the plurality of conductive lines of the second sensor pattern include a plurality of power lines and a plurality of first signal lines each connected to a first end of the second strain gauges, and a plurality of ground lines and a plurality of second signal lines each connected to a second end of the second strain gauges,
the plurality of conductive lines of the third sensor pattern include a plurality of power lines and a plurality of first signal lines each connected to a first end of the third strain gauges, and a plurality of ground lines and a plurality of second signal lines each connected to a second end of the third strain gauges, and
each of the second strain gauges is connected in series to the third strain gauges via the ground lines of the second sensor pattern and the power lines of the third sensor pattern.

4. The strain detection device of claim 3, wherein the controller calculates a first measurement value based on a difference value of detection values of the first strain gauges and the fourth strain gauges, calculates a second measurement value based on a difference value of detection values of the second strain gauges and the third strain gauges, and calculates an average value between the first measurement value and the second measurement value.

5. The strain detection device of claim 2, wherein
the second strain gauges and the third strain gauges are arranged on a center side of the base material in the thickness direction with respect to the first strain gauges and the fourth strain gauges, and
resistance of the second and third strain gauges is higher than that of the first and fourth strain gauges.

6. The strain detection device of claim 5, wherein the resistance of the second strain gauges is the same as the resistance of the third strain gauges, and the resistance of the first strain gauges is the same as the resistance of the fourth strain gauges.
